(19) United States
(12) Patent Application Publication
(10) Pub. No.: US 2012/0283863 A1
(43) Pub. Date: Nov. 8, 2012

(54) RESOURCE SCHEDULING AND ADAPTIVE CONTROL SOFTWARE FOR CUTTING ROOM OPERATIONS

(75) Inventors: Holly Beum, Simsbury, CT (US); Dean Stewart, Moultrie, GA (US)

(73) Assignee: INTERFACE TECHNOLOGIES, Simsbury, CT (US)

(21) Appl. No.: 13/098,604

(22) Filed: May 2, 2011

(51) Int. Cl. G05B 13/04

(52) U.S. Cl. 700/101

(57) ABSTRACT

A method and an apparatus are provided for the use of resource scheduling and adaptive control software to optimize the operations of a manufacturing floor environment, particularly the operations of fabric cutting operations.

### FIELD OF INVENTION

The present invention relates broadly to resource management and scheduling and more particularly to resource scheduling techniques having adaptive control software for cutting room operations.

### BACKGROUND OF THE INVENTION

One of the most critical processes in the manufacturing industry involves resource scheduling. Optimized use of resources, especially in an automated environment can lead to enhanced productivity and reduced operational costs. For example, in manufacturing flexible goods such as apparel or inflatables, allocating available resources in a cutting room in an appropriate manner can optimize the utilization of resources and reduce the total manufacturing time.

Cutting rooms consist of tables on which to spread material. Spreaders are assigned to the tables, and automatic cutting equipment is also provided. Spreaders may either be manual laborers that place material upon the tables or automatic spreading equipment that spreads the fabric from large rolls and allows many layers or plies of material to be spread on the table with accurate alignment and without stretching the material so that the cut pieces do not contract. The number of plies varies and can sometimes reach over 150 layers. Tables can vary in length and support multiple spreads of material, at any given time. The cutting equipment is fed by multiple tables and moves on rails between the tables to perform the many cutting tasks.

In recent years, automation, especially in the form of computer software, has been introduced to enhance operational speed and accuracy. Automatic cutting equipment receives pattern data in a cut file, for example from a CAD system that directs a cutting knife to follow the contours of the patterns. This equipment provides greater accuracy than manual cuts and can cut much larger ply heights in order to allow operators to cut with more efficiency than work performed with manual cutting equipment. During cutting, the cutting machines are moved from table to table, but this movement should be minimized because of lengthy setup time. Cutting room managers thus must optimize several variables at once, including: the utilization of materials, tables, spreaders, cutters, and the labor to perform these tasks.

The cutting room receives new cut orders in addition to existing orders in work and in queue. A cut usually has different styles/sizes/colors with commonalities in material and spread method. A cut is typically comprised of multiple markers which are usually a paper representation on the pattern pieces, and within these markers are bundles that are lower quantity handling units of work. Further adding to the complexity are multi-component cuts which are actually subsets of a cut. For instance a cut of jackets will require the sub cuts of a body shell, lining, and insulation. All of the sub-cuts yields must be scheduled and match in order for all the required component parts to be available to make a complete garment.

Currently, cutting room managers generally rely on spreadsheets, emails, faxes and such, mostly manual, in order to determine that all resources are provided for and available to proceed with the cut. To perform scheduling, cutting room managers generally will use a white board to assign the next highest priority order to a table and spreading equipment. This is a very inefficient use of time and resources. In addition, other factors must be taken into consideration that further complicates the process. At the current cutting consumption rate and move time for all the existing work the manager must decide whether to wait until space becomes available or move the cutting equipment to another table where work is waiting. There are currently no tools or techniques to aid them in this process in determining real-time consumption rates. Thus, managers typically add excess resources to compensate. The resources are utilized, but in actuality create substantially more move and wait time than necessary.

Prior art software available is too generic and is not designed to handle all the input variables including, but not limited to, machine utilization, spreading methods, size and pattern combinations, ply height configurations, multi-component cut logistics, fabric shade and pattern matching, and bundle tracking requirements. Available prior art, unfortunately, does not provide for various inputs to be taken into account in a manner such that resources can be scheduled in an optimized manner using the real-time consumption rates of the resources.

Consequently, new and improved techniques are needed that can take various inputs relating to cutting operations and schedule available resources based on the total consumption rate of all available resources. In addition, it is desirous that as the jobs are queued and completed, real-time data should be used to calculate future jobs, changing the parameters on the fly in order to keep the efficiency of the manufacturing operations at the highest level available.

### SUMMARY OF THE INVENTION

The shortcomings of the prior art are overcome and additional advantages are provided through the provision of a method and apparatus for scheduling optimized resources for cutting operations.

The innovation is configurable software that can model and optimize the complex variables of cutting operations across many industry segments. The software will perform an initialization step in which the system receives manufacturing orders from central systems, marker and cut file availability from the CAD system, material availability from the inventory control system, real-time machine performance, manual operation data (such as typed data fields or barcode scanning), and the consumption requirements and constraints of downstream manufacturing processes. This information is stored in a first memory location within the computer processor.

Subsequently, these inputs will be used by a job scheduling engine to calculate optimized equipment and resource utilization based on this plurality of performance metrics. The system will then establish a job queue based on the calculated optimal resource usage and availability.

As the manufacturing process proceeds, the scheduling engine will dynamically make changes to the initially calculated optimal job schedule by simulating the impact of multiple variables that indicate alterations made to the resource metrics as they are utilized. In order to do this, the system will obtain frequent updates of the status of actual orders and jobs in work, thereby allowing the software to recalculate consumption rates of orders in work and recalculate the optimal job schedule based on multiple-variable sorts of the manufacturing orders to establish operational queue priority.

The processor then stores and updates the calculated optimal job scheduling and resource queue priority in a second memory location that is accessible by the processor based on real-time resource usage. As subsequent tasks are scheduled, this data is accessed by the processor such that resources can continue to be optimally used by constantly fine tuning the optimal resource schedule within the system.

The use of this software is expected to result in a significant increase in cutting productivity, as measured by lower labor costs, greater machine utilization and greater throughput.

Additional features and advantages are realized through the techniques of the present invention. Other embodiments and aspects of the invention are described in detail herein and are considered a part of the claimed invention.

### BRIEF DESCRIPTION OF DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1A is an illustration showing a flow diagram as per one embodiment of the present invention;

FIG. 1B is an illustration of a job scheduling/computing environment used in one embodiment of the present invention;

FIG. 2 is an illustration showing a flow diagram with a focus on adaptive control of resources as per one embodiment of the present invention;

FIG. 3 is an illustration of a block diagram showing general architecture of a system, as per one embodiment of the present invention;

FIG. 4 is an illustration showing a block diagram of a computing environment having multiple resources and interfaces as used in an exemplary manufacturing plant, used in one embodiment of the present invention;

FIG. 5 is an illustration of a flow diagram for calculation of the total direct time for a manufacturing process, as per one embodiment of FIG. 4;

FIG. 6 is an illustration showing a flow diagram for program scheduling process algorithms and multi-variable optimization, as per one embodiment of the present invention; and

FIG. 7 is an illustration of a flow diagram showing effect of the program adaptive control on the scheduling algorithms.

### DETAILED DESCRIPTION

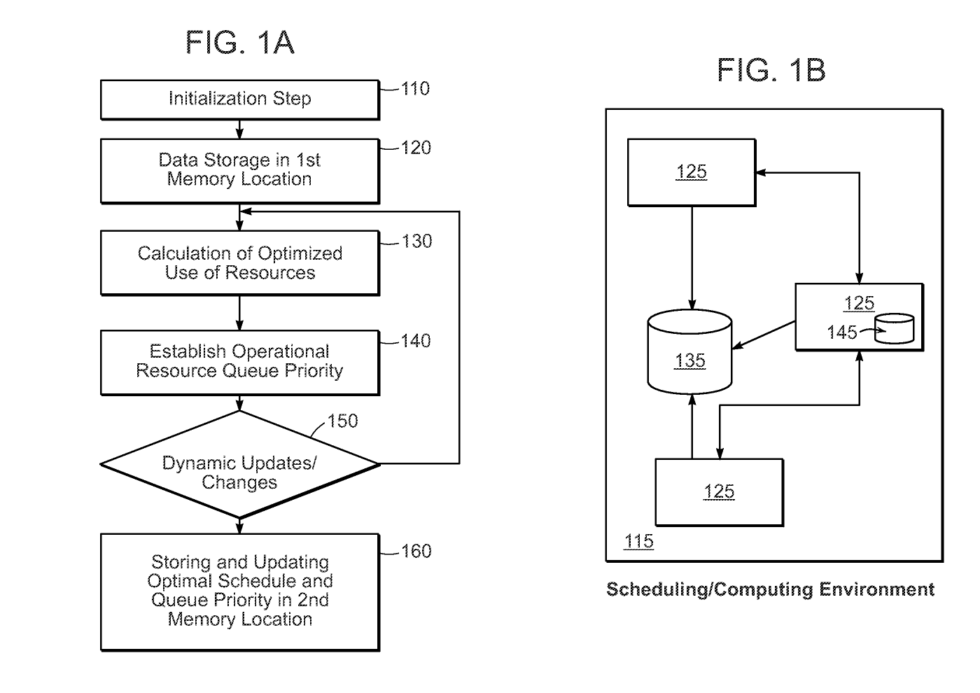

In accordance with an embodiment of the invention, FIG. 1A provides a flowchart showing the steps required for operation of this system as per one embodiment of the present invention. At the onset of a job scheduling an initialization step is performed as represented by step 110 in FIG. 1A. The initialization step can be selectively customized to obtain different types of information relating to one or more resources. This information can come from a variety of sources, including, but not limited to, manufacturing orders from central systems, marker and cut file availability from the CAD system, material availability from the inventory control system, real-time machine performance, manual operation data that may be barcode scanned into the system, and the consumption requirements and constraints of downstream manufacturing processes. This information may also be obtained by one or more users or managers inputting data or can be obtained automatically from a machine, computer or other computing environments (such as over the internet).

During the step indicated by 120, the information previously obtained during the initialization step 110 is stored in a first memory location. At this location, the data represents the initial information known about the system and its resources. The information stored can be retrieved at any time by one or more resource. In addition, each resource can selectively update, alter, or add to this information as appropriate at a later time.

At step 130, the processor uses a job scheduling engine to calculate the optimized use of one or more resources. These calculations will be based on the information that is obtained in 110 and stored in 120.

At step 140, the system will establish an operational resource queue priority. This is based on the optimal job scheduling of the resources that was calculated by the job scheduling engine in 130.

At step 150, changes may be made to the calculated optimal job scheduling. This would be based on any alterations that would be made by the processor and scheduling engine to the resource metrics.

The job scheduling/computing environment is shown as 115 in FIG. 1B. The environment can be a single computing environment comprising of a single processor with a memory location, internal or external to it, or alternatively, it can comprise of a sophisticated system comprising of many nodes with or without internal and/or external memory system. Each node comprises at least a device and the system comprises one or more processors. The nodes/processors are networked together and are in continuous processing communication with one another. In the example shown, one or more external memory locations 135 are used for processing. The nodes include processors and are depicted as 125 in FIG. 1B. These resource processors or nodes, hereinafter referenced interchangeably, communicate with any number of external memory locations to affect the job scheduling and optimal utilization of the resources. As noted in the figure at 145 there may be storage memory locations that are embedded within one or more resource nodes or processors. The resource nodes are also connected together to allow communication within the entire scheduling/computing environment 115 to produce the optimal scheduling routines of one embodiment of the present invention.

At step 160, the processor would store and update the calculated optimal job scheduling and operational resource queue priority in a second memory location. This second memory location is also accessible by the processor such that the resources can be optimally scheduled by the scheduling engine by a continual fine tuning of optimal resource usage. These differing values that reside in the second memory location will be presented to the system through a feedback loop as shown in FIG. 1A for any subsequent job schedules. When there are updated data values in the second memory location changes will be made to the calculated job scheduling at step 150.

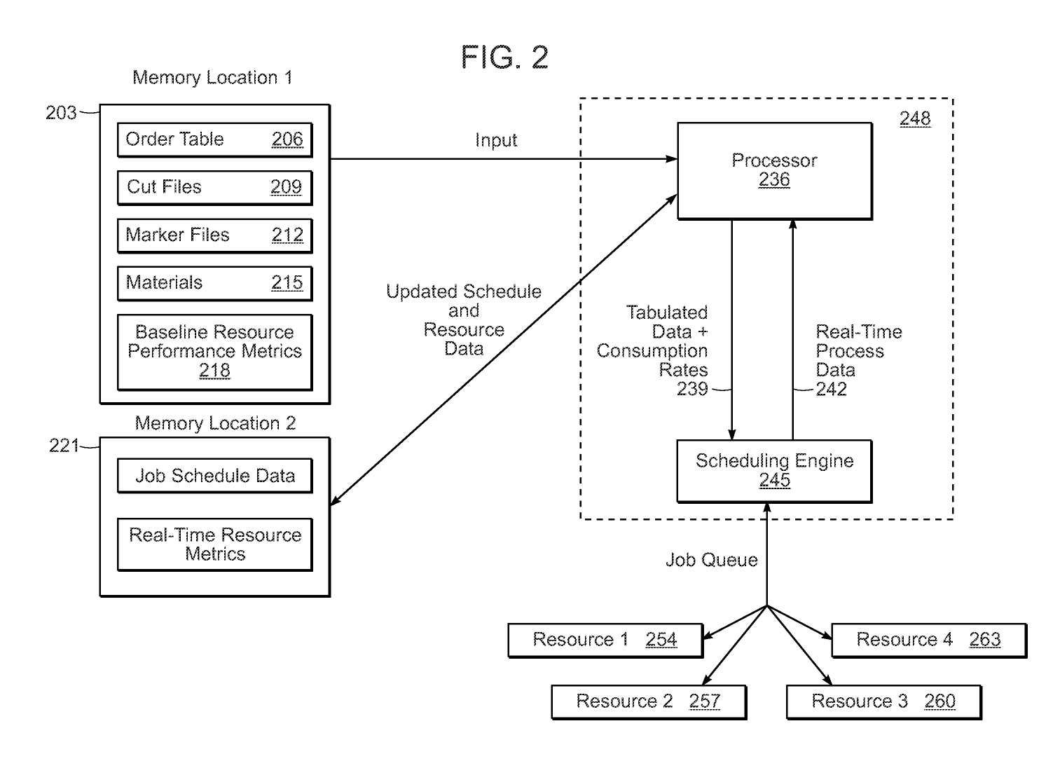

FIG. 2 is a diagram illustrating the adaptive control of resources within the system. The software will perform an initialization step to populate the required data into a first memory location 203. There the system stores data such as manufacturing orders from central systems that go into an order table 206, information on cut files 209, and marker files 212 will be stored. Material availability 215 will be input from the inventory control system, and baseline resource performance metrics 218 are stored here as well. It should be understood that in alternate embodiments additional or different types of data or files can be added as can be appreciated by those skilled in the art. The information included herein is only by means of example to aid understanding.

The information that is stored in this memory location 203 will be read by the processor 236 in order to allow the scheduling engine 245 to calculate an optimized queue for utilization of resources 254, 257, 260, 263. The processor will also read data from a second memory location 221 after the process has run for some time. In this memory location job schedule data is stored as well as real-time resource metrics that are continually updated as the job scheduling engine 245 fine tunes the manufacturing process.

The processor 236 and scheduling engine 245 may reside in one computer as illustrated by the dotted box 248, but this is not a requirement as they may also be remote from one another. Regardless of the configuration, the processor 236 and scheduling engine 245 will exchange information. Tabulated data and consumption rates will be fed to the scheduling engine 245 via communication with the processor 236 along the communication channel 239. Also, communication of real-time process data is communicated along a channel 242 in the reverse direction. The reciprocal communications between the processor 236, scheduling engine 245, resources 254, 257, 260, 263, and the refined data in the second memory location 221 allows this software to provide efficient resource scheduling and fully utilize an adaptive control mechanism to provide the user with the most efficient job scheduling and order queues for the manufacturing operations.

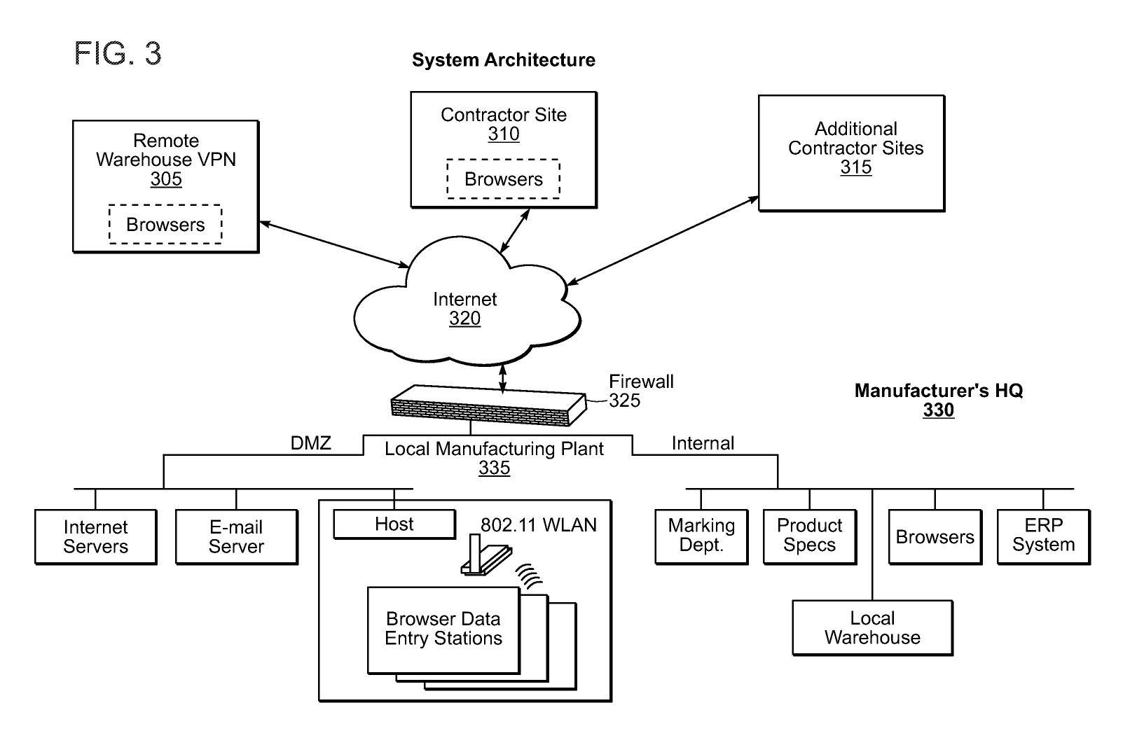

FIG. 3 is a block diagram illustration of a system architecture for the scheduling environment as per one embodiment of the present invention. FIG. 3 illustrates the interconnection of information within and outside a manufacturer's location that may be accessed by this methodology in order to provide the most efficient manufacturing process.

Information will be provided external to the manufacturer's headquarters as shown in 330 via the internet 320 or through other alternative processing communication. External sites could include, but are not limited to, remote warehouses 305 where materials may be stored prior to use as well as contractor sites 310 and 315 that work in conjunction to provide resources to the manufacturer. Alternatively, data can be stored previously internal to the manufacturing plant with minimal processing needs.

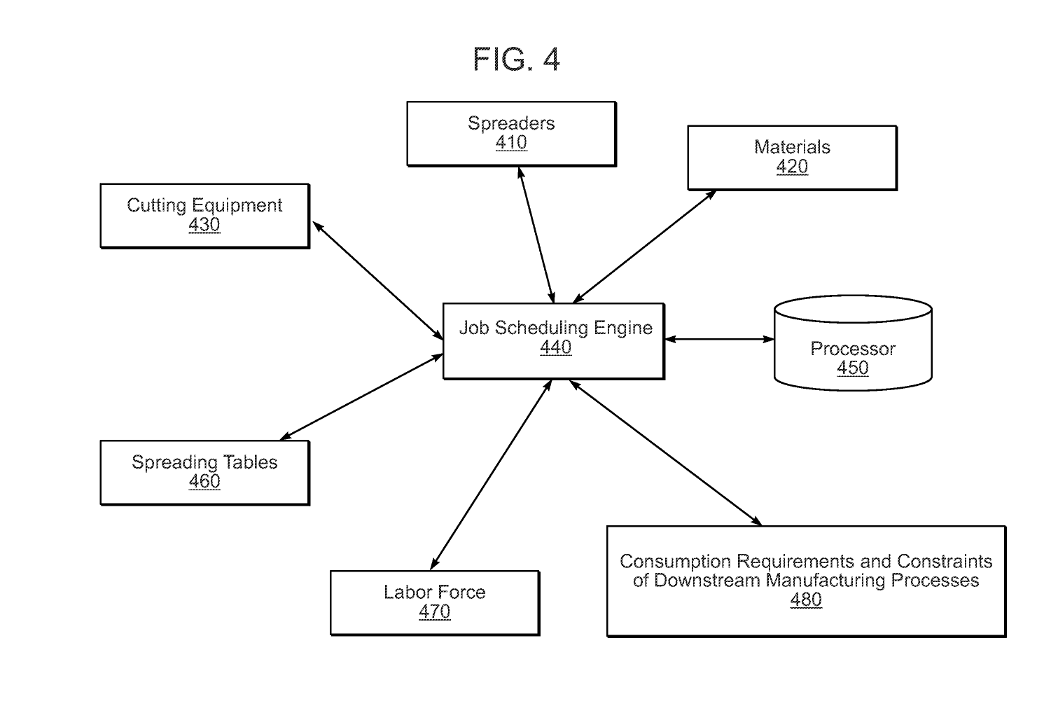

Information will be gathered from the internet or other means as discussed and shown by 320 by the manufacturer through a firewall depicted by 325 in the system. At the manufacturer's headquarters or other such location as depicted in 330 various entities will be able to access the information. The manufacturer's headquarters 330 will house various departments that have interest in the data and will also provide inputs into the manufacturing process. At the local manufacturing plant 335, the system would compile the data that is required for optimum job scheduling. This data, received internally and externally to the plant 335 would be used to initialize the process 110 and would be stored in the first 203 or second 221 memory locations being accessed by the processor 236 and scheduling engine 245 at the manufacturing plant 335. It can be appreciated by those skilled in the art that FIG. 3 and FIG. 4 (as follows) is only one example of a plurality of embodiments and the use of manufacturing plants, headquarters of the like are only used as an example to aid understanding and therefore should not create processing limitations.

FIG. 4 is a diagram showing the computer interfaces with various resources that are located within the local manufacturing plant 335. This illustration is for the preferred embodiment as used in cutting operations of the sewn goods industry.

In this embodiment the system is controlling the resources required to cut and assemble material for a clothing manufacturer. In one example, the automatic cutting equipment 430 will receive pattern data from a computer processor that directs the cutting knife to follow the pattern contours in a precise manner. The scheduling engine 440, being used by processor 450, will control when this occurs based on the availability of the resources and the queue that has been established. Other resources are illustrated that relate to the preferred embodiment. These include spreaders 410, materials 420, spreading tables 460 and the labor force 470. The scheduling engine also takes into account the consumption requirements and constraints of downstream manufacturing processes 480 that will have an effect on determining the optimized scheduling of resources. The different elements depicted here can represent or be represented by nodes/processors of FIG. 1B as discussed previously.

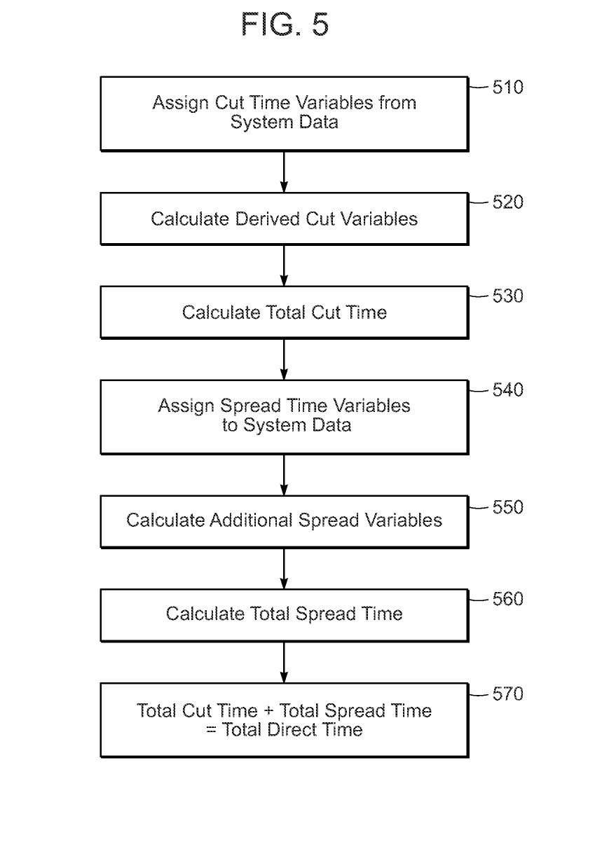

FIG. 5 is a flow diagram for the calculation of the “Total Direct Time” of a manufacturing process. Further details are described below that indicate the data required and calculations that are used by the processor and scheduling engine to determine the operational queue priority using the flow diagram in FIG. 5. The processor will be used to calculate the “Total Direct Time” of the operations in order to be used by the scheduling engine. Job times must be calculated in order for the scheduling engine to calculate the “Remaining Time to Complete Cut” in order to allow the processor and scheduling engine to determine the subsequent steps required for efficient completion of tasks and optimum utilization of resources.

Cutting Time Calculations—The “Total Cutting Time” will identify the amount of time the cutting equipment and operators will be committed for, and this value is a component of the “Total Direct Time” of each order. In this example a plurality of variables are selected and assigned from the system data. To aid understanding an exemplary table, Table 1, is created below. However, as can be appreciated by those skilled in the art, other information can be provided in alternative embodiments.

The following variables are assigned from the system data, 510:

TABLE 1
Example variables from system data

| Variable | Description | Data Source |
|---|---|---|
| TCP1 | Total of piece perimeters in the cut in inches | CAD cut file |
| TCP2 | Total number of pieces in the cut | CAD cut file |
| TCL | Length of the cut in linear inches | CAD cut file |
| CS | Cutting speed of the cutting head in inches | Automatic Cutting |
| | per minute | Equipment |
| PMT | Move time of the cutting head from piece to | Automatic Cutting |
| | piece in minutes | Equipment |
| CLT | Cut head linear travel ability in inches | Automatic Cutting |
| | | Equipment |
| CLTS | Set up time per CLT movement in minutes | Operation data |
| CV | Speed of the conveyor in inches per minute | Automatic Cutting |
| | | Equipment |
| OEF | Operation Efficiency Factor, as percent | Adaptive Control |
| | | Table |
| CST | Cut Set Up Time in minutes | Operation data |

The following additional derived variables can be calculated, 520:
TCL/CV=Minutes of Conveyor Move Time (MCMT)
TCL/CLT (rounded to next whole number)=Number of Conveyor Moves (NCM)
NCM*CLTS=Minutes to Conveyor Moves Set Up Time (MCMTS)
TCP1/CS=Minutes of Cut Time (MCT)
TCP2*PMT=Minutes of Piece Move Time (MPMT)

These variables are used in the final calculation for total cutting time 530 and cutting consumption rate using the following equations:

(MCMT+MCMTS+MCT+MPMT+CST)/OEF=Total Cutting Time (TCT)

TCL/TCT=Cutting Consumption Rate for Cut (in linear inches per minute)

Where it is possible, for cut orders in work calculate the cutting consumption rate per marker section for the cut order and get notification from the automated cutting machine of time to begin cut of a section within the cut. This will allow the user to interactively fine tune the consumption rate for a particular cut.

Spreading Time Calculations—The “Total Spreading Time” will identify the amount of time the spreading table equipment and operators will be committed for and is required as a component of the “Total Direct Time.”

The following variables are assigned to the system data 540, as shown in Table 2:

TABLE 2
Example variables assigned to system data

| Variable | Description | Data Source |
|---|---|---|
| CST | Minutes per order to obtain marker(s) | Operation data |
| | and review cutting specifications | |
| PST | Minutes to deploy marker to table | Operation data |
| MST | Minutes per marker to mark splice points | Operation data |
| SSA | Minutes to Adjust Spreading Machine | Operation data |
| | and Stops | |
| MLR | Minutes to Load Roll | Operation data |
| SS | Spreading Speed in yards per minute | Spreading equipment |
| ST | Spreader Travel in yards per minute | Automatic spreading |
| | | equipment |
| STF | Spreader Travel yards Factor | 0 = Face-to-Face and |
| | | Face Up; 1 = Face Up |
| | | One Directional |
| CRT | Minutes per Carriage Rotation | Spreading equipment |
| CRF | Carriage Rotation Factor | 0 = Face-to-Face and |
| | | Face Up One |
| | | Directional; |
| | | TCY/TCL = Face Up |
| DT | Minutes to cut out or mark defect | Operation data |
| OEF | Operation Efficiency Factor, as percent | Operation data |
| DY | Number of Defects per Yard | Operation data |
| NM | Number of Markers | Manufacturing Order |
| | | Data |
| TNR | Total Number of Rolls | Manufacturing Order |
| | | Data |
| TCL | Total Cut Length | CAD Cut file |
| TCY | Total Cut Yards | Manufacturing Order |
| | | Data |

The following additional variables can be calculated, 550:
PST*NM*2=Minutes to Deploy/Take Up Markers (MMT)
MST*NM=Minutes to Mark Ends and Splice Points (MNT)
PST*NM=Minutes to Put Down Underlayment (MUT)
TCY/SS=Minutes of Spread Time (MS)
TCY/ST*STF=Minutes of Travel Time (MT)
(TCL*0.5)*(TNR)/ST=Minutes of Travel Time to Load Rolls (MRT)
MLR*TNR−1=Minutes to Load Rolls (MLT)
CRT*CRF=Minutes of Carriage Rotation (MCT)
TCY/DY*DT=Minutes of Defects (MDT)

These variables are used in the final calculation for total spread time 560 using the following equations:

(CST+MMT+MNT+MUT+SSA)/OEF=Minutes of Spread Set Up Time (XSST)

(MS+MT+MRT+MLT+MCT+MDT)/OEF=Minutes of Spreading Time (XST)

(XSST+XST)=Total Spreading Time (TST)

Total Direct Time—When two unscheduled orders have the same due date and priority code, the Total Direct Time will be used as a tie breaker in the scheduling engine to determine which of the cut orders will be scheduled first. The order with the greatest Total Direct Time will be scheduled first, to allow it the best opportunity to be completed by the due date. Total Direct Time is also used in the scheduling engine to estimate, when associated with other orders in a schedule, the “Remaining Time to Complete Cut.” From the above calculations and data the Total Direct Time 570 can be obtained by adding TST+TCT.

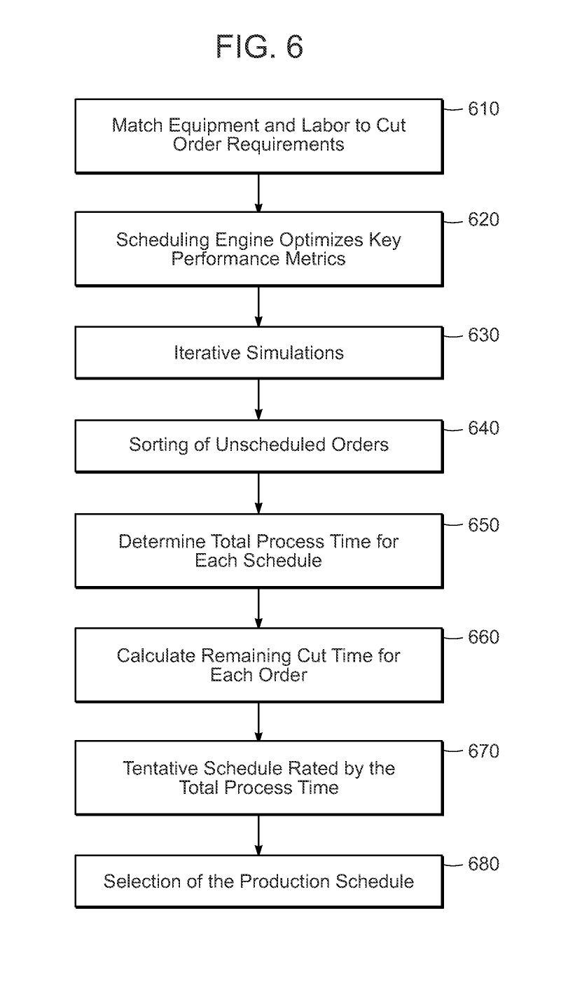

FIG. 6 is a depiction of the process for program scheduling algorithms and multi-variable optimization. Configuration tables will match available equipment and labor to the requirements of each cut order in step 610. In one example embodiment a plurality of variables are used as data such as fabric type, fabric width, and spread method information that will be matched to the spreading equipment capabilities. The selected spreading equipment is then assigned to a spreading table, which in turn is then assigned to a cutter.

These types of relationships will be defined in various data tables but will include Factory Table, Work Center Table, Equipment Tables, Order Header, Order Detail, Component Detail, etc.

The scheduling engine will optimize key performance metrics in step 620 by iteratively simulating 630 the impact of multiple variables. The system will sort all unscheduled orders in step 640 by Required Date (ascending)/Order Priority Code (ascending)/Total Direct Time (descending). This yields a list of orders listed in sequence of importance for optimization. For each of the potential schedules, the processor will determine the Total Process Time in step 650. These values are based on the sequence in which orders fall in a tentative schedule.

For each order the system will calculate and update to each order the “Remaining Time to Complete Cut” in step 660. This value for a cut that is in-work at the cutting operation is dependent only on itself, and can be calculated as: (Current Time−Start Time of Cut)=Total Time in Cut (expressed in minutes). Total Cutting Time−Total Time in Cut=“Remaining Time to Complete Cut”

“Remaining Time to Complete Cut” for a cut that is in-work, at the spreading operation, is dependent on itself the order that is directly in front of it in the queue and can be calculated as: (Current Time−Start Time of Spread)=Total Time in Spread (expressed in minutes). (Total Spread Time−Total Time in Spread+the “Remaining Time to Complete Cut” of the order directly in front of it in the queue)=“Remaining Time to Complete Cut” of the current order.

The “Remaining Time to Complete Cut” for a cut that is not started work and is 4^{th} in queue in a Work Group is equal to the sum of Cut Order 3's “Remaining Time to Complete Cut”+Cut Order 4's “Total Direct Time.”

That tentative schedule will be rated by the Total Process Time in step 670. (Total Process Time=the greatest “Remaining Time to Complete Cut” of any order in the schedule). Based on this performance metric (shortest Total Process Time) the “best” sequence of orders will be selected in step 680 as the production schedule.

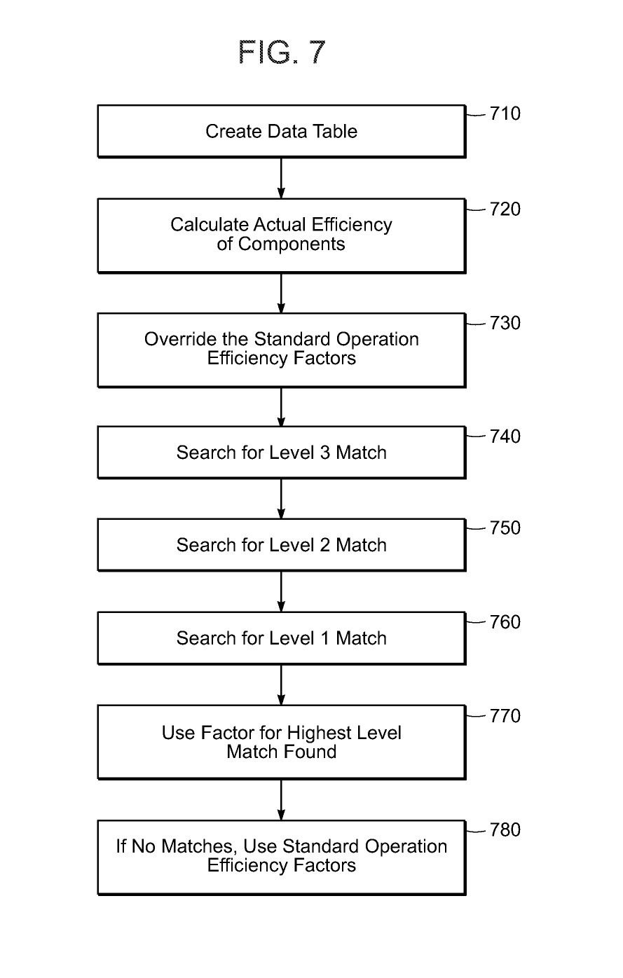

FIG. 7 is an illustration of a flow diagram showing effect of the program adaptive control on the scheduling algorithms. As per one embodiment of the present invention, a data table will be created in step 710 with the following information: Factory ID, Level Code (1=Work Center, 2=Model ID/Model Part, 3=Operator ID), Experience Counter, Operation ID, Work Center ID, Model ID, Model Part Number, Operator ID, Current Efficiency Factor, Total Efficiency Factor, Date Created, Date Last Updated

At the completion of each operation for a cut order, a program will calculate the actual efficiency in step 720 for that Operation/Work Center/Model/Part Number/Operator ID. The Adaptive Scheduling Efficiency Factor table records for Level 1, 2, & 3 records will be created or updated.

The scheduling engine will override the Standard Operation Efficiency Factor (OEF) of each operation as depicted in step 730, first searching for a Level 3 (Work Center, Model & Part, and Operator) match as shown in step 740. If no match is found, then the scheduling engine will search for a Level 2 (Work Center, Model & Part) match as depicted in step 750. Again, if no match is found, then the scheduling engine will search for a Level 1 (Work Center) match in step 760. Once a match has been found then the factor for the highest level match will be used as in step 770. If none of these level criteria provide a match, the standard OEF will be used in step 780 by the system to produce a schedule queue.

These operations are intended to achieve two goals. First, to use actual operating results to improve the schedule. Second, when those resources are available, to ensure that the highest priority orders are assigned to the most efficient equipments and operators.

While the invention has been described in accordance with certain preferred embodiments thereof, those skilled in the art will understand the many modifications and enhancements which can be made thereto without departing from the true scope and spirit of the invention, which is limited only by the claims appended below.

What is claimed is:

1. A method of modeling and optimizing resource operations, comprising the steps of:
performing an initialization step during which information is obtained relating to one or more resources;
storing said information in a first memory location of a processor;
said processor using a job scheduling engine to calculate, based on said stored information, optimized use of said one or more resources based on a plurality of performance metrics;
establishing operational resource queue priority based on said calculated optimal job scheduling of said resources by said scheduling engine;
said processor dynamically providing changes to said calculated optimal job scheduling based on alterations made to said resource metrics;
said processor storing and updating said calculated optimal job scheduling and operational resource queue priority in a second memory location accessible by said processor, such that said resources can be optimally scheduled by said scheduling engine continually fine tuning optimal resource usage.

2. The modeling method as set forth in claim 1, wherein said information obtained during said initialization step relating to one or more resources, includes a plurality of parameters and fields.

3. The modeling method as set forth in claim 2, wherein said plurality of parameters and fields further comprise one or more of data relating to manufacturing orders, resource availability, prior history of performance, and prior history of operation completion time.

4. The modeling method as set forth in claim 1, wherein said performance metrics are obtained by simulating impact of multiple operational and resource related variables.

5. The modeling method as set forth in claim 4, wherein said variables include one or more of consumption rates of resources and optimal job scheduling times calculated from said consumption rates are utilized to optimize resource utilization.

6. The modeling method as set forth in claim 5, wherein said resources include one or more of data relating to labor force, cutting tables availability, fabric spreaders details, fabric cutters availability, and combinations of aforementioned resources.

7. The modeling method as set forth in claim 1, further comprising the step of establishing communication between an adaptive control and said processor; and fine-tuning said optimization of job scheduling through said communication step.

8. The modeling method as set forth in claim 7, wherein said adaptive control component obtains data dynamically related to resource usage and further generates a plurality of scheduling algorithms for continuous optimization of job schedule(s).

9. The modeling method as set forth in claim 8, wherein said scheduling algorithms are used to calculate the available sequence of resource actions to be selected in order to complete any task in a shortest process time.

10. The modeling method as set forth in claim 8, wherein said scheduling engine is enabled to detect variations from said initial resource allocation and if such determined variations are significant; performing an additional step of updating said scheduling engine by said algorithms to incorporate current resource utilization times to calculate an optimal job scheduling of said resources.

11. The modeling method as set forth in claim 1, wherein said optimal use of said one or more resources is determined by said processor based on minimum total time said one or more resources will be utilized.

12. The modeling method as set forth in claim 1, further comprising the step of said processor calculating a Total Direct Time parameter that represents the total amount of time available resources are utilized to complete a task, said parameter calculated based on a plurality of inputs and then utilized by the scheduling engine to set a scheduling task order to optimize meeting production due dates.

13. The modeling method as set forth in claim 12, further comprising the steps of said processor calculating a Total Cutting Time parameter that represents the total amount of time cutting equipment and operator(s) will be utilized to complete a task; and calculating a Total Spreading Time parameter that represents the total amount of time spreading table equipment and operator(s) will be utilized to complete a task.

14. The modeling method as set forth in claim 12, further comprising the steps of said processor calculating a Total Direct Time by adding Total Cutting Time and Total Spreading Time; and setting a job sequence in order of descending Total Direct Time to allow opportunity for completion by the jobs' due date.

15. The modeling method as set forth in claim 12, further comprising the step of said processor using resource relationship data to match available resources to the schedule requirements of each order.

16. The modeling method as set forth in claim 12, further comprising the steps of calculating optimized resource usage by said scheduling engine by:
a) simulating in iterative fashion impacts of multiple variable configurations grouped differently on manufacturing operations;
b) sorting all unscheduled orders resulting in a list of orders in sequence of importance for optimization;
c) rating a tentative schedule based on Total Process Time;
d) providing a “best” sequence of orders for said production schedule.

17. The modeling method as set forth in claim 1, further comprising the steps of calculating, via said processor, upon completion of each operation for a cut order, an actual efficiency metric for all said available resources.

18. The modeling method as set forth in claim 17, comprising the following steps:
creating or updating actual efficiency metrics in said processor;
overriding the Standard Operating Efficiency Factor for each operation by the scheduling engine;
using actual operating results to improve task schedule;
utilizing available resources so that highest priority orders are assigned to the most efficient resources.

19. A computer system used for resource optimization, comprising:
a processor;
a plurality of resources in processing communication with said processor;
said processor obtaining information about said resources when said resources become available to said system and dynamically updating said information when there are changes to availability of said resource;
a memory location in processing communication with said processor for storing current or previous information about each resource availability and history;
said processor also storing information about each resource past and current performance times;
said processor using said information about each resource to schedule job requests received by said processor based on each resource history and availability to achieve optimal resource usage for each received job request.

20. A computer program product comprising an optimized resource scheduling and management tool including a computer usable medium having computer readable program code means for causing a computer to effect method steps of:
performing an initialization step during which information is obtained relating to one or more resources;
storing said information in a first memory location of a processor;
said processor using a job scheduling engine to calculate, based on said stored information, optimized use of said one or more resources based on a plurality of performance metrics;
establishing operational resource queue priority based on said calculated optimal job scheduling of said resources by said scheduling engine;
said processor dynamically providing changes to said calculated optimal job scheduling based on alterations made to said resource metrics;
said processor storing and updating said calculated optimal job scheduling and operational resource queue priority in a second memory location accessible by said processor, such that said resources can be optimally scheduled by said scheduling engine continually fine tuning optimal resource usage.
